(19) United States
(12) Patent Application Publication
(10) Pub. No.: US 2010/0085329 A1
(43) Pub. Date: Apr. 8, 2010

(54) Optical touch display device, optical touch sensing device and touch sensing method

(75) Inventors: Ping-Chen Tseng, Kaohsiung City (TW); Chung-Hao Tien, Taipei County (TW)

Correspondence Address: COVENANT IP CONSULTING CO., P.O. BOX 34-306 TAIPEI CITY, TAIPEI, 10499, TW

(73) Assignee: National Chiao Tung University, Hsinchu (TW)

(21) Appl. No.: 12/505,476

(22) Filed: Jul. 18, 2009

(30) Foreign Application Priority Data
Oct. 3, 2008 (TW) 097138199

(51) Int. Cl. G06F 3/042

(52) U.S. Cl. 345/175

(57) ABSTRACT

The present invention provides an optical touch display device, an optical touch sensing device, and a method for calculating a touch position. The optical touch sensing device can be detachably attached on a display panel using adhesive or other method. The present invention includes a first light source, a second light source, a light sensing element, and a processing unit. When an object blocks the path of light, some light sensing elements will receive some or no light. The processing unit will then compute two line segments based on the positions of light sensing elements receiving some or no light. The two line segments cross each other and their intersection is defined as the position of object or the touch position.

### BACKGROUND OF THE INVENTION

1. Field of the Invention

This invention relates to a touch sensing device; and more specifically to an optical touch display device, an optical touch sensing device, and a touch sensing method thereof.

2. Description of the Prior Art

Flat panels and flat display devices using the flat panels are gradually becoming the mainstream in various types of display devices. For instance, panel displays, home flat televisions, flat screen monitors used in personal computers and laptops, and display screens of mobile phones and digital cameras are electronic products extensively incorporating flat panels. As more and more consumers are now demanding that the electronic products have user friendliness, pithy appearance and multi-functionality, flat display devices having touch sensing function are now gradually becoming the mainstream in the flat display devices. The touch sensing panels used in flat display devices include capacitive touch panel, resistive touch panel, surface acoustic wave touch panel, and optical imaging touch panel. The optical imaging touch panels have advantages of high reliability, scratch resistance, and fire resistance. Furthermore, as the quality of light emitting diodes used in the optical imaging touch panel improves, the optical image touch panels are extensively adopted in flat display devices.

United States patent publication US2001/0055006 A1 discloses a scan-type optical imaging touch panel and a touch sensing method thereof. The scan-type optical imaging touch panel includes a panel, a reflector layer disposed along the edge of the panel, a judging unit, two light receiving elements, two laser light sources and two stepper motors, wherein the stepper motors are used to rotate the laser light sources. Laser from the laser light sources travels in directions parallel to the panel. The laser is then reflected or refracted back to the light receiving elements, wherein the light receiving elements will output electrical signals to the judging unit based on the strength of laser received and its reception angle. The judging unit will determine if an object has blocked the laser based on the rotation angle of stepper motors and the electrical signals which represents the strength and the reception angle of laser. If one object (such as a finger or a pen) blocks the path of laser, the light receiving element which has not yet received laser will output a corresponding electrical signal to the judging unit. The judging unit then calculates the touch location or the location of the object based on the rotation angle of stepper motors and the electrical signal received.

Furthermore, the United States patent publication US 2007/0165008 A1 also discloses an infrared touch sensing display device. The infrared touch sensing display device includes a plurality of infrared transmitter and a plurality of infrared detector disposed around the display panel. Each infrared transmitter corresponds to an infrared detector. The infrared lights emitted from infrared transmitters are received respectively by corresponding infrared detectors to form an infrared matrix. When an object is placed in the infrared matrix and blocks the infrared. The infrared touch sensing display device then calculates the position of the object based on the locations of infrared detectors not receiving infrared.

In the patent applications mentioned above, the United States patent publication US 2001/0055006 A1 requires stepper motors and motor controllers to control the emission angle of laser in order to scan. In this way, the use of stepper motors and motor controllers will increase the manufacture cost of scan-type optical image touch panels. Furthermore, the calculation of touch location requires the input parameter of emission angle of laser, which also increases the overall cost of calculation.

As for the United States patent publication US 2007/0165008 A1, the working principle requires the formation of an infrared matrix. Thus, a plurality of infrared transmitters and infrared detectors are required, resulting in a structure of higher overall power consumption and higher production cost.

### SUMMARY OF THE INVENTION

It is an object of the present invention to provide an optical touch display device and an optical touch sensing device for reducing the elements required and the overall cost.

It is another object of the present invention to provide an optical touch display device and an optical touch sensing device with reduced power consumption.

It is another object of the present invention to provide an optical touch sensing device to be detachably attached on a display panel for providing the display panel with the touch sensing function.

It is yet another object of the present invention to provide a method for calculating a touch position on a touch panel.

The optical touch display device includes a first light source, a second light source, a plurality of light sensing elements, and a display panel. The light sensing elements are disposed close to the periphery of the display panel. The first light source and the second light source are spaced by at least two light sensing elements. The first light source and the second light source simultaneously emit light towards the light sensing elements covering display panel. The light includes invisible infrared, but is not limited thereto; in different embodiments, the light includes visible light of different wavelengths or other invisible lights.

Furthermore, the optical touch display device further includes a processing element electrically connected to the light sensing elements. The light sensing elements generates a sensing signal in accordance with the strength of the light received. Each light sensing element has a signal level, wherein the signal level represents the amplitude of the sensing signal when the light sensing element receives substantially no light. The light sensing element mentioned above which does not receive light directly from the first light source or the second light source but from external environment. Otherwise, an amplitude or phase difference will occur between the sensing signal generated by the light sensing element and the corresponding signal level. The processing unit will determine positions of the light sensing elements not receiving light based on the amplitude or phase difference between the sensing signal and the signal level. The processing unit then calculates two line segments crossing each other based on the positions of light sensing elements not receiving light. Lastly, the processing unit will calculate the position of the intersection of line segments and define the position as the touch position or location of the object.

The present also provides an optical touch sensing device for being detachably attached on a display device using adhesive or other methods. The optical touch sensing device includes a first light source, a second light source, a plurality of light sensing elements, a processing element and a frame. The frame has an opening preferably corresponding to an active area of the display device. In this way, the sensing area of the optical touch sensing device corresponds to the active area of the display device.

Furthermore, the present invention also provides a method for calculating a touch position on a touch panel. The method includes emitting a light toward at least one light sensing element using at least a first light source and a second light source. The first light source, the second light source, and the light sensing element are disposed close to a periphery of a display panel or on a frame. The method also includes comparing a sensing signal generated by each light sensing element with a corresponding signal level of the light sensing element to obtain a first reference position and a second reference position. The method then includes calculating a first line segment based on the first reference position and a position of the first light source and calculating a second line segment based on the second reference position and a position of the second light source, wherein the first line segment intersects the second line segment. Finally the method includes calculating a touch position based on the first line segment and the second line segment

### BRIEF DESCRIPTION OF THE DRAWINGS

FIG. 1 is a top view of an optical touch display device of the present invention, wherein a first light source and a second light source are disposed on two opposite corners of a display panel;

FIG. 2 illustrates another top view of the optical touch display device, wherein an object is placed in the middle of a traveling path of light;

FIG. 3 illustrates a variation of the optical touch display device illustrated in FIG. 1 and FIG. 2, wherein the first light source and the second light source are disposed on two opposite sides of a display panel;

FIG. 4 is a top view of another variation of the optical touch display device of the present invention, wherein the first light source and the second light source are disposed on two adjacent sides of the display panel;

FIG. 5 is a top view of yet another variation of the optical touch sensing display device, wherein the first light source and the second light source are disposed on two ends of one side of a display panel;

FIG. 6 is a top view of an optical touch sensing device of the present invention;

FIG. 7 is a flow chart of a method for calculating a touch position on a touch panel;

FIG. 8 illustrates another embodiment of the method illustrated in FIG. 7;

FIG. 9 illustrates yet another embodiment of the method illustrated in FIG. 7; and

FIG. 10 illustrates a variation of the method illustrated in FIG. 9.

### DETAILED DESCRIPTION OF THE PREFERRED EMBODIMENT

The present invention provides an optical touch display device, an optical touch sensing device, and a touch sensing method thereof, which emits and receives a light simultaneously and determines whether an object blocks a path of light based on the strength of light received. Light emitted from the optical touch display device and the optical touch sensing device of the present invention preferably includes invisible infrared, but is not limited thereto; in different embodiments, light can include invisible light or visible lights of different wavelengths. The optical touch display device or the optical touch sensing device will determine a position of the object blocking the light and define the position of the object as the touch position. Furthermore, the optical touch display device of the present invention includes a liquid crystal display device, but is not limited thereto; in different embodiments, the optical touch display device can include organic light emitting diode (OLED) display device or other display devices requiring touch sensing function.

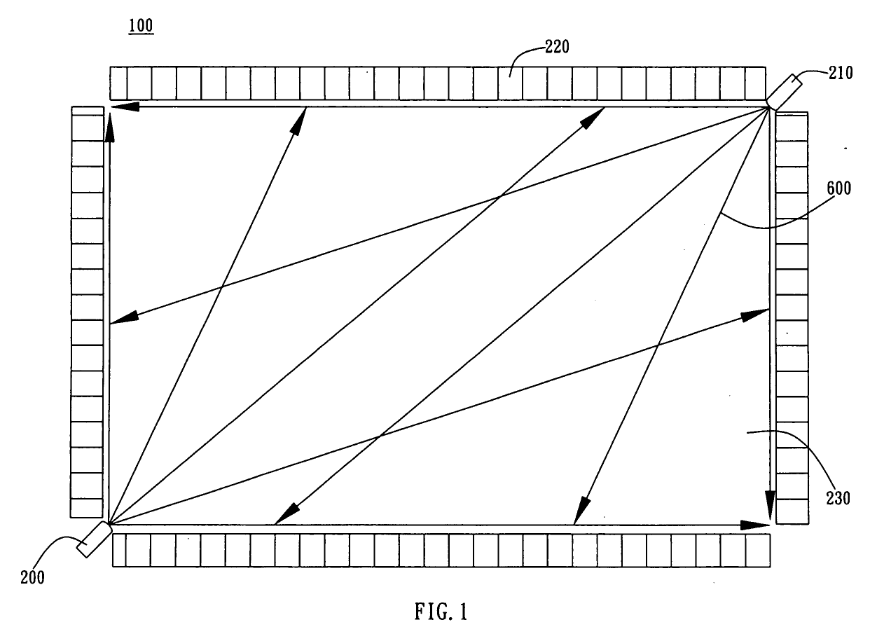

FIG. 1 is a perspective view of the optic touch display device 100 of the present invention. The optical touch display device 100 includes a first light source 200, a second light source 210, a plurality of light sensing elements 220, and a display panel 230. As FIG. 1 shows, the optical touch display device 100 or the display panel 230 are rectangular, but is not limited thereto; the display panel 230 can be circular or have other suitable shapes. The light sensing elements 220, the first light source, and the second light source 210 are disposed close to a periphery of the display panel 230. Furthermore, the light sensing elements 220 are electrically connected to a processing unit. The first light source 200 and the second light source 210 are disposed at two opposite corners of the display panel 230. Thus, the first light source 200 and the second light source 210 emit light 600 substantially toward each other. The path of the light 600 is substantially parallel to the display panel 230 and the light 600 substantially covers the display panel. In the present embodiment, the optical touch display device 100 includes a light diffusion device (not illustrated), wherein light diffusion device has a light incident surface and a light exit surface. Light 600 enters the light incident surface and then exits from the light exit surface according to a diffusion angle. The diffusion angle mentioned above is preferably less than 90° and can be adjusted according to the number of light sources employed, the arrangement of the light sources, or other factors.

In the embodiment illustrated in FIG. 1, the first light source 200, the second light source 210, and each light sensing element 220 respectively has a position. Those positions form a coordinate system which is stored in a storage section of the processing unit. The coordinate system is used to calculate a touch position on the display panel 230. In other words, the coordinate system corresponds to substantially the entire area of the display panel 230. The coordinate system adapted in the present embodiment is a two-dimensional Cartesian coordinate system, but is not limited thereto. In different embodiments, the coordinate system can include two-dimensional bipolar coordinate system or other suitable coordinate systems.

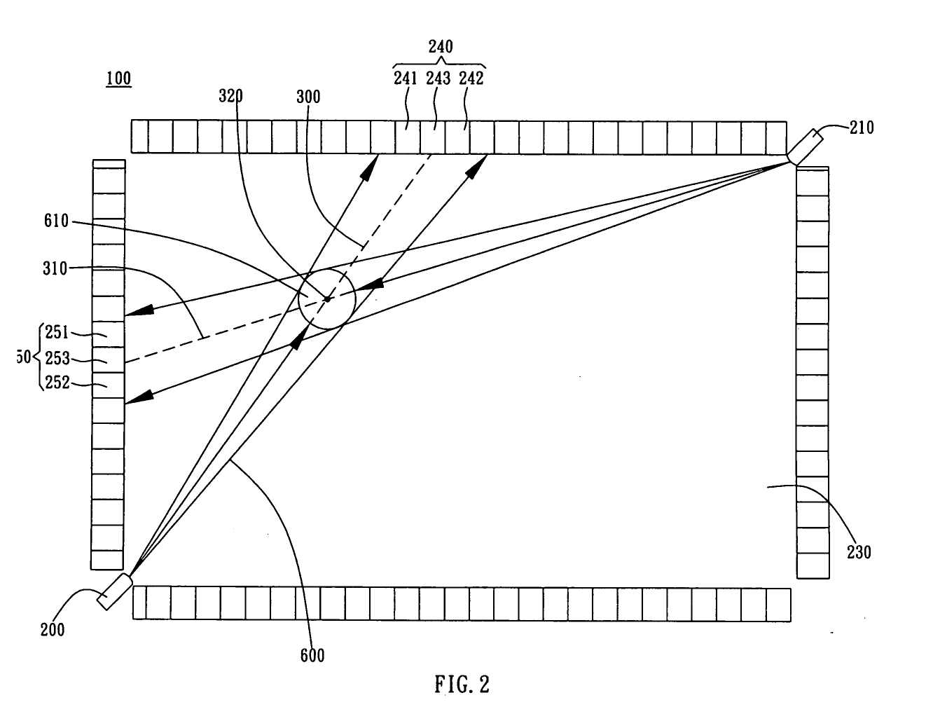

FIG. 2 illustrates another top view of the optical touch display device, wherein an object is placed in the middle of a traveling path of light. In the embodiment illustrated in FIG. 1 and FIG. 2, each light sensing element 220 sends out a sensing signal to the processing unit according to the strength of the light 600 received. Furthermore, each light sensing element 220 is assigned with a specific signal level, wherein the signal level can represent the amplitude of the sensing signal when the light sensing element 220 does not receive light 600. The processing unit then determines if the light sensing element 220 receives light 600 from light sources by comparing the sensing signal from the light sensing element 220 with the corresponding signal level. In other words, the processing unit determines if the light is blocked based on the amplitude or phase difference between the sensing signal generated by the light sensing element 220 and the corresponding signal level.

As FIG. 2 shows, an object 610 is disposed on the display panel 230 and blocks the path of the light 600. Due to the obstacle of the object 610, pluralities of light sensing elements 220 can only partially receives light 600 or even receive no light 600 at all. Thus sensing signals from those light sensing elements 220 and the corresponding signal levels have an amplitude or a phase difference satisfying the definition of not receiving light 600. Those light sensing elements 220 defined as not receiving light are classified into a first non-illuminated group 240 and a second non-illuminated group 250. After confirming the occurrence of the first non-illuminated group 240 and the second non-illuminated group 250, the processing unit will obtain positions of two light sensing elements 220 at two ends of the first non-illuminated group 240. The above-mentioned two light sensing elements 220 are respectively defined as a first light sensing element 241 and a second light sensing element 242. Similarly, light sensing elements 220 located at two ends of the second non-illuminated group 250 are respectively defined as a third light sensing elements 251 and a fourth light sensing element 252.

In the embodiment illustrated in FIG. 2, the processing unit will determine a first reference element 243 based on the positions of the first light sensing element 241 and the second light sensing element 242. The first reference element 243 is situated preferably in the middle of the first non-illuminated group 240. Similarly, the processing unit will determine a second reference element 253 based on the positions of the third light sensing element 251 and the fourth light sensing element 252. The second reference element 253 is situated preferably in the middle of the second non-illuminated group 250. However, in different embodiments, the first reference element 243 can be situated anywhere between the first light sensing element 241 and the second light sensing element 242. The second reference element 253 can be situated anywhere between the third light sensing element 251 and the fourth light sensing element 252. In other words, the algorithm of the processing unit to determine the first reference element 243 and the second reference element 253 can be adjusted. The first reference element 243 and the second reference element 253 respectively have a first reference position and a second reference position. The processing unit uses the first reference position and the position of the first light source 200 to calculate a first line segment 300. Similarly, the processing unit uses the second reference position and the position of the second light source 210 to calculate a second line segment 310, wherein the first line segment 300 and the second line segment 310 cross at an intersection 320. The processing unit then calculates the position of the intersection 320 which is then defined as the location of the object 610 or the touch position. The position of the intersection 320 is then transmitted to a back-end processor in a form of electrical signal for further touch position processing.

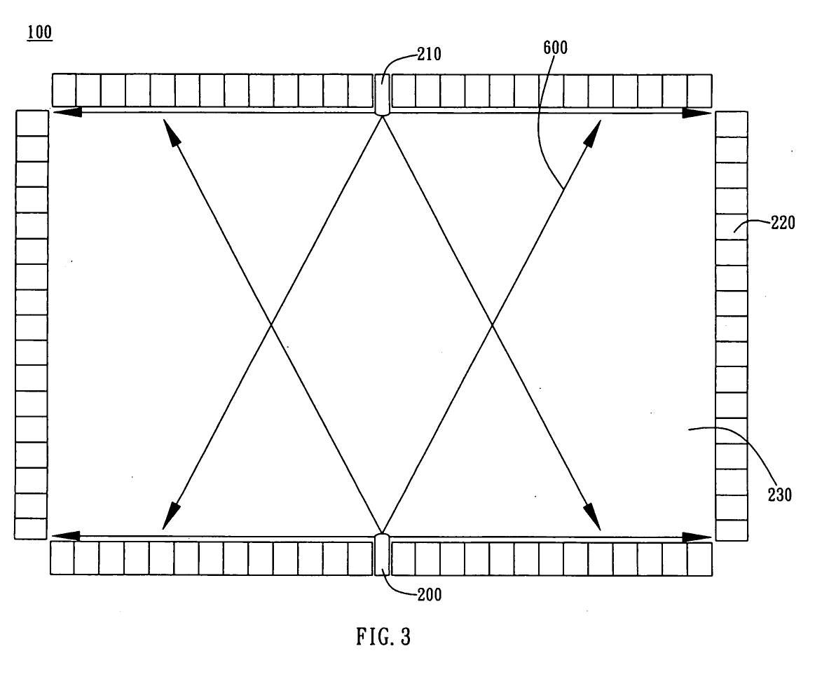

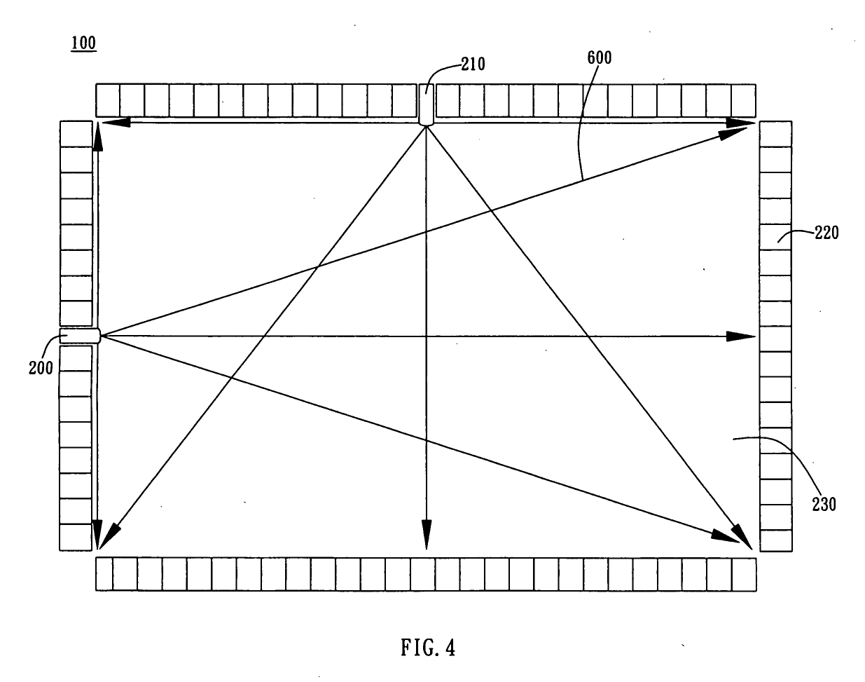

FIG. 3 and FIG. 4 illustrate a variation of the embodiment of the optical touch display device 100. As FIG. 3 shows, the first light source 200 and the second light source 210 are disposed at the centers of two opposite sides of the display panel 230. The first light source 200 and the second light source 210 preferably emit light 600 in an angle of 180° and light 600 preferably covers the display panel 230. In the present embodiment, a light sensing element 220 may receive light 600 from both the first light source 200 and the second light source 210. Thus the signal level of each the light sensing element 220 needs to be adjusted in accordance with a distance between light sensing element 220 and the first light source 200 and the second light source 210 as well as light's 600 incident angle to the light sensing element 220. FIG. 4 illustrates another embodiment of the optical touch display device 100 of the present invention. As FIG. 4 shows, the first light source 200 and the second light source 210 are disposed at centers of two adjacent sides of the display panel 230. The working principle of the optical touch display device 100 and its components are substantially the same as the optical touch display device 100 illustrated in FIG. 1 and FIG. 2 and thus will not be repeated here.

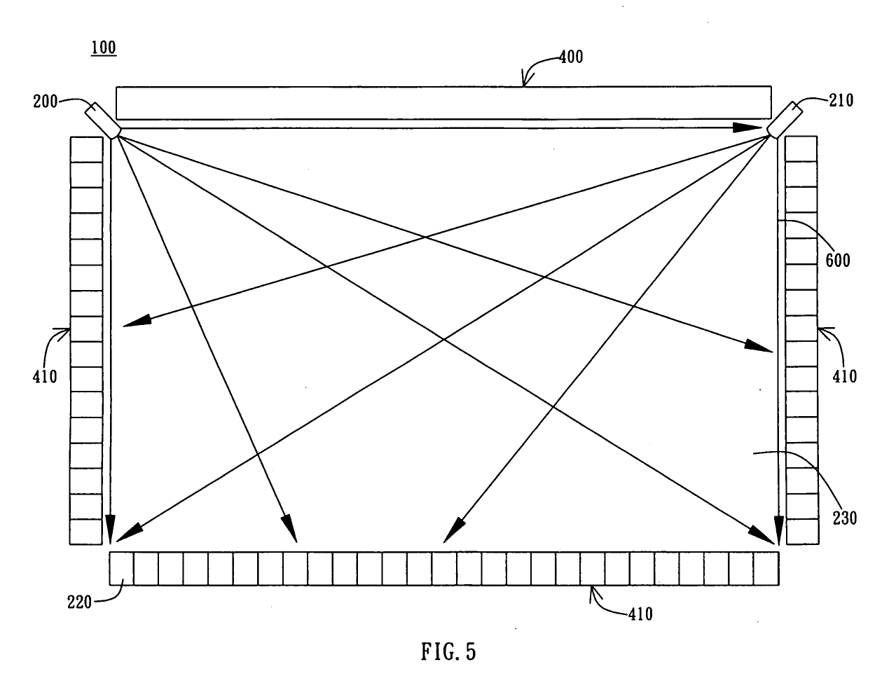

FIG. 5 is a top view of yet another variation of the optical touch sensing display device. As FIG. 5 shows, the optical touch display device 100 includes a light source side 400 and three element disposition ends 410. In the present embodiment, the light source side 400 is one of the longer end of the optical touch display device 100, but is not limited thereto. In different embodiments, the light source side 400 can be any other end of the optical touch display device 100. A plurality of light sensing elements 220 are disposed on the element disposition ends 410. Furthermore, in the present embodiment, the first light source 200 and the second light source 210 are disposed respectively at two ends of the light source side 400 and emit light 600 toward light sensing elements 220 on the element disposition ends 410. However, in different embodiments, the first light source 200 and the second light source 210 can be disposed at different sections of the light source side 400.

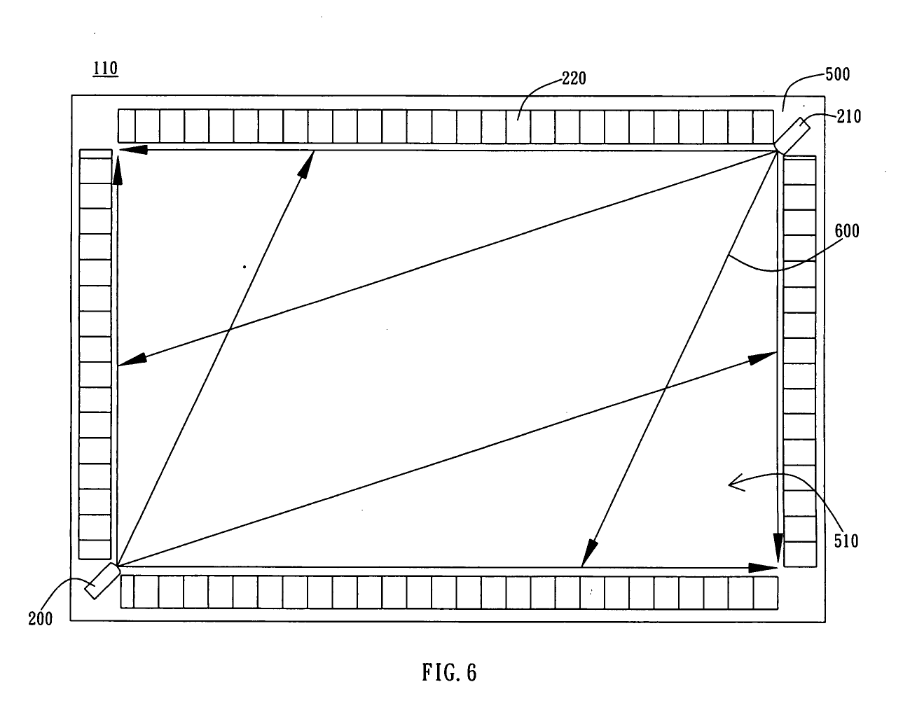

FIG. 6 is a top view of the optical touch sensing device 110 of the present invention. As FIG. 6 shows, the optical touch sensing device 110 can be detachably attached on a display device for providing the display device with the touch sensing function. Furthermore, in different embodiments, the optical touch sensing device 110 can be attached on the display device using adhesives or other methods. The optical touch sensing device 110 is preferably attached to a liquid crystal display device, but is not limited thereto. In different embodiments, the optical touch sensing device 110 can be attached to an organic light emitting diode (OLED) display device or other display device requiring the touch sensing function.

As FIG. 6 shows, the optical touch sensing device 110 includes a frame 500, a first light source 200, a second light source 210, and a plurality of light sensing elements 220, wherein the first light source 200, the second light source 210, and the light sensing elements 220 are disposed on the frame 500. Furthermore, the optical touch sensing device 110 also includes a processing unit electrically connected to the light sensing elements 220. The light sensing elements 220 receive the light emitted from the first light source 200 and the second light source 210. The strength of light is then converted into electrical signals for the processing unit to process. In the present embodiment, the frame 500 is rectangular, but is not limited thereto. The size and shape of the frame 500 as well as the number of elements disposed on the frame 500 can be adjusted in accordance with the size of the display device. Furthermore, the optical touch sensing device 110 includes an opening 510 surrounded by the frame 500, wherein the opening 510 preferably corresponds to an active area of the display device. In this way, the sensing area of the optical touch sensing device 110 corresponds to the active area of the display device.

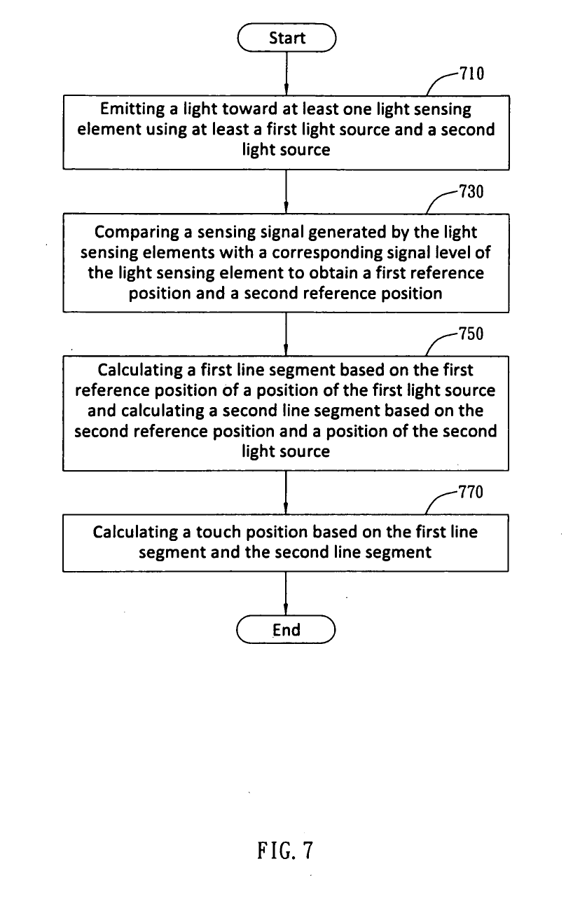

Furthermore, the present invention also provides a method for calculating a touch position. As FIG. 7 shows, step 710 includes emitting a light toward at least one light sensing element using at least a first light source and a second light source. The light is preferably invisible infrared, but is not limited thereto. The light can include invisible light or visible lights of different wavelengths. Furthermore, the first light source, the second light source, and the light sensing elements are preferably disposed close to the periphery of a display panel, but are not limited thereto. In different embodiments, the first light source, the second light source, and the light sensing element can be disposed on a frame. Step 730 includes comparing a sensing signal generated by the light sensing elements with a corresponding signal level of the light sensing element to obtain a first reference position and a second reference position. The amplitude of the sensing signal is preferably directly proportional to the strength of light received, but is not limited thereto; in different embodiments, the amplitude of the sensing signal generated can be inversely proportional to the strength of light. Each light sensing element has a signal level for determine if the light sensing element receives light or not. Furthermore, distances between each light sensing element and the light sources are different and thus strengths of lights received are different. Therefore, the signal level of each light sensing element is preferably adjusted according to the distance between the light sensing element and the light sources.

Step 750 includes calculating a first line segment based on the first reference position of a position of the first light source and calculating a second line segment based on the second reference position and a position of the second light source. In the present embodiment, the first line segment and the second line segment are straight lines across the display panel and cross each other. Step 770 includes calculating a touch position based on the first line segment and the second line segment. In the present embodiment, the touch position is preferably an intersection of the first line segment and the second line segment, but is not limited thereto.

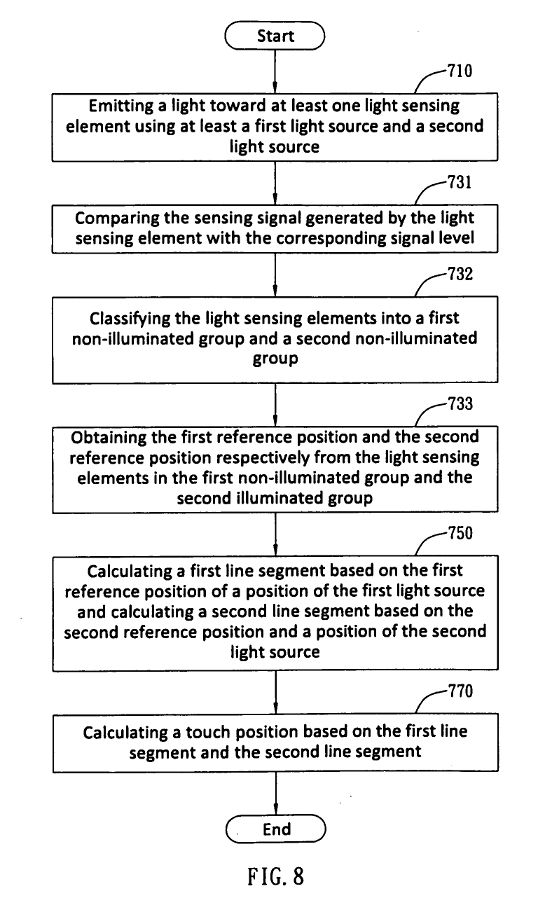

FIG. 8 illustrates another embodiment of the method illustrated in FIG. 7. In the present embodiment, the method further includes step 731 of comparing the sensing signal generated by the light sensing element with the corresponding signal level of the light sensing element. Step 732 includes classifying the light sensing elements into a first non-illuminated group and a second non-illuminated group. Step 733 includes obtaining the first reference position and the second reference position respectively from the light sensing elements in the first non-illuminated group and the second illuminated group.

In the embodiment illustrated in FIG. 8, the first non-illuminated group and the second non-illuminated group respectively includes at least one light sensing element. The amplitude of the sensing signal from the light sensing element in the first non-illuminated or in the second non-illuminated is lower than the corresponding signal level, but is not limited thereto. In different embodiments, amplitude of the sensing signal from the light sensing element in the first non-illuminated or in the second non-illuminated can be higher than or equal to the corresponding signal level.

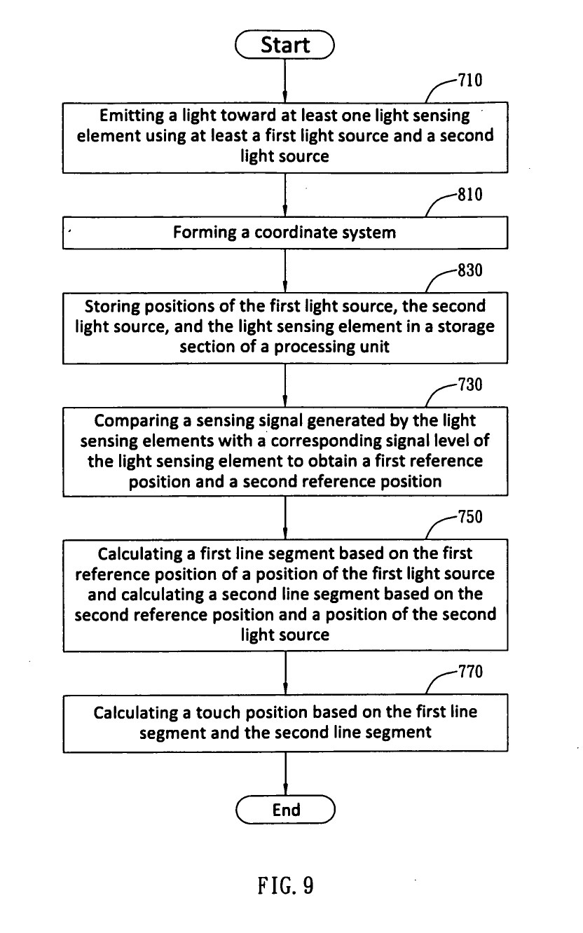

FIG. 9 illustrates yet another embodiment of the method illustrated in FIG. 7. As FIG. 9 shows, the method for calculating a touch position further includes step 810 of forming a coordinate system and step 830 of storing positions of the first light source, the second light source, and the light sensing element. In the present embodiment, the position information is stored in a storage section of a processing unit. The coordinate system of the present embodiment is a two-dimensional Cartesian coordinate system, but is not limited thereto; in different embodiments, the coordinate system can includes two-dimensional bipolar coordinate system or other suitable coordinate systems. Furthermore, the coordinates of the coordinate system correspond to an active area of the display panel. In other words, a point on the display panel has a corresponding coordinate in the coordinate system.

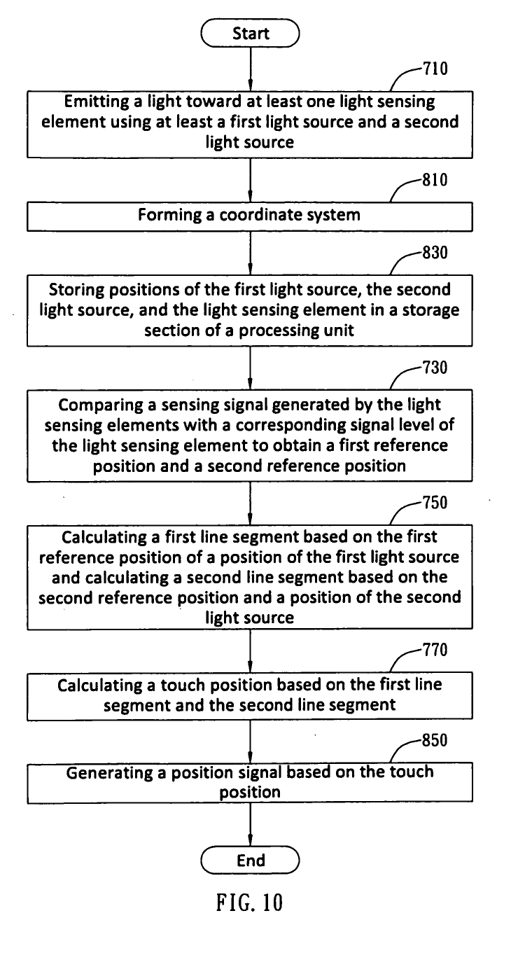

FIG. 10 illustrates a variation of the method illustrated in FIG. 9. In the embodiment illustrated in FIG. 10, the method further includes step 850 of generating a position signal based on the touch position. In the present embodiment, the position signal is an electrical signal to be processed by a back-end processor.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. An optical touch display device, comprising:
a display panel;
at least a first light source and a second light source disposed close to a periphery of the display panel for substantially simultaneously emitting a light, wherein a traveling direction of the light is substantially parallel to the display panel, the light emitted from the light sources substantially covers the display panel;
at least one light sensing element disposed close to the periphery of the display panel, the light sensing element detects a strength of the light and outputs a sensing signal based on the strength of the light; and
a processing unit electrically coupled to the light sensing element, wherein the processing unit receives the sensing signal and generates a position signal based on the sensing signal.

2. The optical touch display device of claim 1, wherein the display panel includes an element disposition end and a light source end, the light sensing element is disposed at the element disposition end.

3. The optical touch display device of claim 2, wherein the first light source and the second light source are disposed on different parts of the light source end, the first light source and the second light source emit the light substantially toward the element disposition end.

4. The optical touch display device of claim 1, wherein the display panel is rectangular, the first light source and the second light source are respectively disposed on two opposite corners of the display panel.

5. The optical touch display device of claim 4, wherein the light emitted from the first light source travels toward two sides of the display panel next to the second light source, the light emitted from the second light source travels toward two sides of the display panel adjacent to the first light source.

6. The optical touch display device of claim 1, wherein an amplitude of the sensing signal of the light sensing element is directly proportional to the strength of the light, each light sensing element has a corresponding signal level, the processing unit selectively generates the position signal based on a difference between the amplitude of the sensing signal and the signal level of the light sensing element.

7. The optical touch display device of claim 1, wherein the light sensing element has an element position, the first light source and the second light source respectively have a first light source position and a second light source position;
the element position, the first light source position, and the second light source position together form a coordinate system, the element position, the first light source position and the second light source position respectively correspond to coordinates of the coordinate system, the processing unit has a storage section for storing the element position, the first light source position and the second light source position.

8. The optical touch display device of claim 7, wherein an amplitude of the sensing signal is directly proportional to the strength of the light, each light sensing element has a corresponding signal level, the processing unit calculates the position signal based on a difference between the sensing signal and the signal level of the light sensing element to obtain the element position of the light sensing element from the storage section based on the position signal.

9. The optical touch display device of claim 8, wherein the at least one of the light sensing element includes a first light sensing element and a second light sensing element respectively corresponding to the first light source or the second light source, if the sensing signals generated by the first light sensing element and the second light sensing element vary with respect to the corresponding signal level, the processing unit calculates a reference location based on the element positions of the first light sensing element and the second light sensing element, the processing unit then calculates a line segment across the display panel.

10. The optical touch display device of claim 9, wherein the reference location is located between the first light sensing element and the second light sensing element.

11. The optical touch display device of claim 9, wherein when the processing unit has at least two line segments crossing each other, the processing unit outputs the position signal based on an intersection position of the line segments.

12. The optical touch display device of claim 9, wherein when the amplitudes of the sensing signals generated by the light sensing elements vary with respect to the corresponding signal levels, the processing unit calculates the reference location based on two element positions of the light sensing elements.

13. The optical touch display device of claim 1, wherein the first light source is disposed on a side or a corner of the display panel, the second light source is disposed on an opposite side or an opposite corner of the display panel.

14. The optical touch display device of claim 1, further comprising a light diffusion device, wherein the light diffusion device has a light incident surface and a light exit surface, the light emitted from the light sources enters the light incident surface and then exits from the light exit surface according to a diffusion angle.

15. The optical touch display device of claim 1, wherein the light includes a visible light or an invisible light.

16. An optical touch sensing device disposed close to a display panel, the optical touch sensing device comprising:
a frame disposed near an edge of the display panel;
at least a first light source and a second light source disposed close to an edge of the frame for substantially simultaneously emitting a light, wherein a traveling direction of the light substantially parallel to the display panel, the light emitted from the light sources substantially covers the display panel;
at least one light sensing element disposed on the display panel and disposed near an edge of the display panel, the light sensing element detects a strength of the light and outputs a sensing signal based on the strength of the light; and
a processing unit electrically coupled to the light sensing element, wherein the processing unit receives the sensing signal and generates a position signal based on the sensing signal.

17. A method for calculating a touch position on a touch panel, comprising the following steps:
emitting a light toward at least one light sensing element using a first light source and a second light source, wherein the first light source, the second light source, and the light sensing element are disposed close to a periphery of a display panel or an edge of a frame;
comparing a sensing signal generated by each light sensing element with a corresponding signal level of the light sensing element to obtain a first reference position and a second reference position;
calculating a first line segment based on the first reference position and a position of the first light source and calculating a second line segment based on the second reference position and a position of the second light source, wherein the first line segment intersects the second line segment; and
calculating a touch position based on the first line segment and the second line segment.

18. The method of claim 17, wherein the step of obtaining the first reference position and the second reference position further includes the following steps:
comparing the sensing signal generated by each light sensing element with the corresponding signal level of the light sensing element;
classifying the light sensing elements into a first non-illuminated group and a second non-illuminated group based on the comparison result; and
obtaining the first reference position and the second reference position respectively from the light sensing elements in the first non-illuminated group and the second non-illuminated group.

19. The method of claim 17, further comprising a step of generating a position signal based on the touch position.

20. The method of claim 17, further comprising the following steps:
forming a coordinate system, wherein coordinates of the coordinate system respectively correspond to positions of the first light source, the second light source, and the light sensing element; and
storing positions of the first light source, the second light source, and the light sensing element.
